(19) United States
(12) Patent Application Publication
(10) Pub. No.: US 2025/0153239 A1
(43) Pub. Date: May 15, 2025

(54) BATTERY COMPONENT CONTINUOUS CASTING MACHINE WITH QUICK-CHANGE BELT CASTER WHEEL ASSEMBLY AND METHOD INVOLVING SAME

(71) Applicant: Wirtz Manufacturing Company, Inc., Port Huron, MI (US)

(72) Inventors: Michael R. Romeo, St. Clair, MI (US); Aleksander Mrdjenovic, Fort Gratiot, MI (US); Jason P. Miller, St. Clair, MI (US)

(21) Appl. No.: 18/942,924

(22) Filed: Nov. 11, 2024

Related U.S. Application Data
(60) Provisional application No. 63/548,060, filed on Nov. 10, 2023.

(51) Int. Cl. B22D 11/06; H01M 4/68; H01M 4/73

(52) U.S. Cl. CPC B22D 11/0651; B22D 11/0602; H01M 4/68; H01M 4/73

(57) ABSTRACT

A battery component continuous casting machine is equipped with a quick-change belt caster wheel assembly. Battery components produced include lead-based metal grids for lead-acid battery types, as well as lead-based metal foils for bipolar battery types. Caster wheels of the quick-change belt caster wheel assembly are more readily installed and uninstalled—making removal and replacement procedures easier—while preserving precision tolerances often demanded for proper manufacture of the battery component grids and foils.

### CROSS-REFERENCE TO RELATED APPLICATION

This application claims the benefit of U.S. Provisional Patent Application No. 63/548,060, with a filing date of Nov. 10, 2023, the contents of which are hereby incorporated by reference in their entirety.

### TECHNICAL FIELD

This disclosure relates generally to equipment for battery component manufacture and, more particularly, to a machine for continuously casting battery components such as battery foils and battery grids.

### BACKGROUND

Batteries are a common source of electrical energy and are often used as automotive batteries, marine batteries, consumer equipment batteries, small engine batteries, industrial batteries, as well as other mobile and stationary applications. Different types of batteries have different components.

Certain types of lead-acid batteries, for example, include numerous positive and negative plates made of lead-based alloy metal grids with an electrochemically-active battery paste material applied thereon. The grids serve as the current conductor or collector of the established electrode, and the paste material serves as the active electrochemical material of the electrode. Making lead-based grids, and particularly those of the positive kind, remains an important part in the manufacture of commercially suitable lead-acid batteries. It often involves considerable metallurgic microstructure control to impart satisfactory mechanical strength, corrosion resistance, creep resistance, paste adhesion, as well as other sought-after properties.

Batteries with bipolar architectures, on the other hand, are chemistry agnostic but most are of the lead-acid type. Bipolar batteries typically have individual electrochemical cell compartments that are isolated by current collectors. Each current collector, also called a bipole, has positive electrochemically active material at one side and has negative electrochemically active material at an opposite side. Bipoles can take the form of a thin foil composed of a lead-based alloy metal. Still, efficient commercial production of thin foil bipoles remains an industry challenge.

### SUMMARY

In an embodiment, a quick-change belt caster wheel assembly for a battery component continuous casting machine is provided. The quick-change belt caster wheel assembly may include a base assembly, a caster wheel, and a thermal management assembly. The base assembly can be situated atop the battery component continuous casting machine, and may include a ring gear and a multitude of bearings. The bearings facilitate rotation of the ring gear. The caster wheel is carried by the base assembly. The caster wheel can be rotated with respect to the base assembly. The caster wheel is driven to rotate by way of the ring gear. The caster wheel has a cylindrical wall. A mold cavity resides in the cylindrical wall. The thermal management assembly is located between the base assembly and the caster wheel. The thermal management assembly attenuates heat transfer between the caster wheel and the base assembly.

In an embodiment, a method of changing a belt caster wheel assembly in a battery component continuous casting machine may involve placing a base assembly of the belt caster wheel assembly at a frame wall of the battery component continuous casting machine. The placement occurring primarily by way of a side or lateral direction and movement of said base assembly with respect to the frame wall.

In an embodiment, a belt caster wheel assembly for a battery component continuous casting machine is provided. The belt caster wheel assembly may include a caster wheel, a ring gear, a ring component, and a multitude of load-bearing balls. The caster wheel has a mold cavity. The ring gear drives rotation of the caster wheel. The ring component is situated between the ring gear and the caster wheel. The ring component has one or more coolant passages that reside therein. The multitude of load-bearing balls are situated between the ring component and the caster wheel. An axial gap resides between the ring component and the caster wheel near the multitude of load-bearing balls.

### BRIEF DESCRIPTION OF THE DRAWINGS

Certain embodiments of the disclosure are described with reference to the appended drawings, in which:

FIG. 1 is a perspective view of an embodiment of a battery component continuous casting machine equipped with an embodiment of a quick-change belt caster wheel assembly;

FIG. 2 is a top view of the battery component continuous casting machine;

FIG. 3 is a side view of the battery component continuous casting machine;

FIG. 4 is a rear view of the battery component continuous casting machine;

FIG. 5 is a sectional view of the battery component continuous casting machine taken at arrowed line 5-5 in FIG. 4;

FIG. 6 is a sectional view of the battery component continuous casting machine taken at arrowed line 6-6 in FIG. 4;

FIG. 7 is a sectional view of an embodiment of a shoe taken at arrowed lines 7-7 in FIG. 2;

FIG. 8 is a perspective view of the battery component continuous casting machine with the quick-change belt caster wheel assembly uninstalled;

FIG. 9 is a perspective view of the quick-change belt caster wheel assembly;

FIG. 10 is a sectional view of the quick-change belt caster wheel assembly;

FIG. 11 is another sectional view of the quick-change belt caster wheel assembly;

FIG. 12 is an enlarged view of an embodiment of components of a thermal management assembly of the quick-change belt caster wheel assembly;

FIG. 13 is a sectional view of an embodiment of components of the thermal management assembly of the quick-change belt caster wheel assembly; and

FIG. 14 is an enlarged view of taken from FIG. 13.

### DETAILED DESCRIPTION

With reference to the figures, an embodiment of a battery component continuous casting machine 10 (hereafter, continuous casting machine) equipped with a quick-change belt caster wheel assembly 12 is shown and described herein. Battery components made by the continuous casting machine 10 include lead-based metal grids for lead-acid batteries and lead-based metal foils for bipolar batteries, among other possible components. The battery components are serially-connected in a strip as they exit the continuous casting machine 10. Compared to previous devices, caster wheels of the continuous casting machine 10 are more readily installed and uninstalled, making removal and replacement procedures quicker and easier. Caster wheels can call for changing due to use and wear over time, can call for substitution and swapping to employ a different caster wheel diameter or battery component mold cavity or mold cavity pattern, and/or for cleansing purposes, among other possible reasons for removal and replacement. The quick-change belt caster wheel assembly 12 is designed and constructed to establish and preserve the precision tolerances demanded for proper manufacture of the subject battery components upon installation and uninstallation procedures of the quick-change belt caster wheel assembly 12 at the continuous casting machine 10 and amid operation, as described in greater detail below. Overall, a more effective and efficient continuous casting machine and process and procedure for caster wheel installation and uninstallation is furnished, enhancing facilitation of commercial and mass production operations.

The continuous casting machine 10 can be employed in operation to continuously cast a strip of a multitude of serially-connected lead-acid battery metal grids or a strip of a multitude of serially-connected bipolar battery foils. The continuous casting machine 10 can be part of a larger casting system and line that may further include a liquid lead supply and delivery system equipped upstream of the continuous casting machine 10, and a coiling machine equipped downstream of the continuous casting machine 10 (the terms upstream and downstream are used here with reference to the general direction of forward manufacturing progression of the battery components). In general, the continuous casting machine 10 has been shown to produce battery components of metal composition exhibiting a desirably relatively small grain size, relatively uniform grain size, and a crystal morphology throughout the metal structure. It has been determined that these enhanced grain properties are due in part or more to the machine's gravity-fed liquid lead delivery capabilities, as subsequently set forth. The continuous casting machine 10 can have varying designs, constructions, and components in varying embodiments. In the embodiment of the figures, the continuous casting machine 10 includes—as its primary components and assemblies—the quick-change belt caster wheel assembly 12, a moveable belt 14, a multitude of rollers, a multitude of shoes, a belt tensioning assembly 16, and a frame 18. Still, in other embodiments, the continuous casting machine could have more, less, and/or different primary components and assemblies.

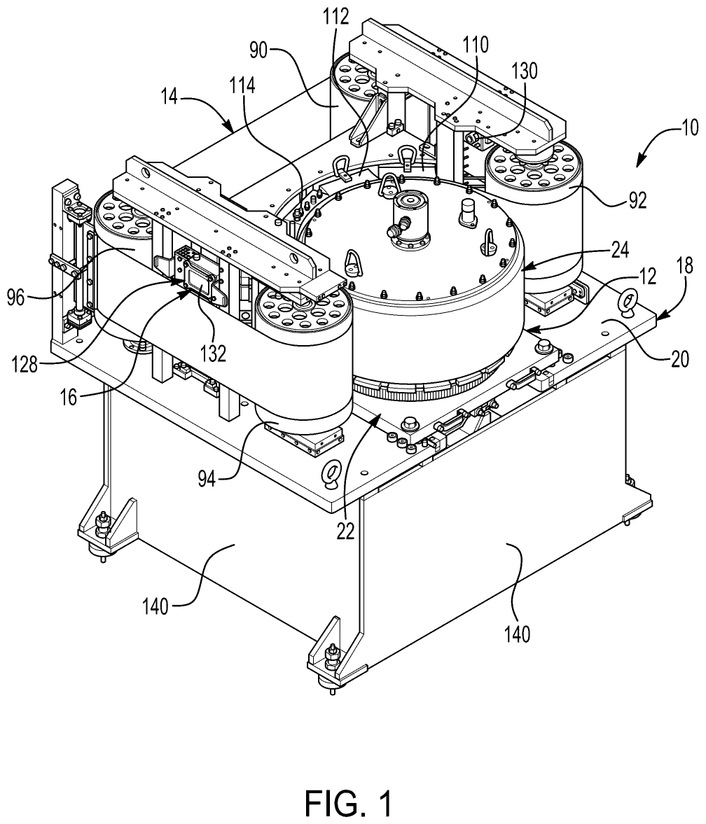

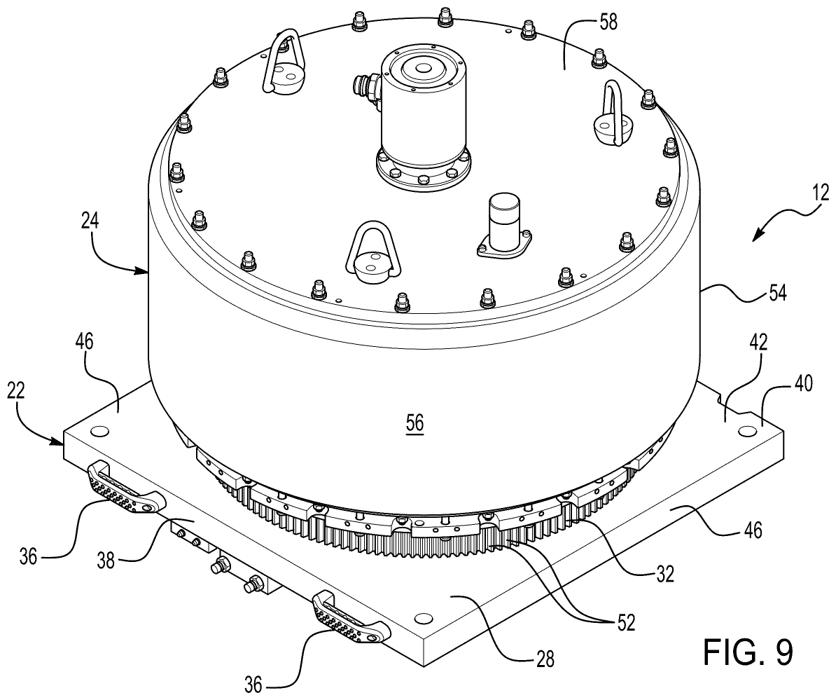

The quick-change belt caster wheel assembly 12 (hereafter, caster wheel assembly) is more readily installed in, and uninstalled from, the continuous casting machine 10. When installed, as depicted in FIG. 1, the caster wheel assembly 12 is set in place and supported at a top wall 20 of the frame 18. The caster wheel assembly 12 can have varying designs, constructions, and components in varying embodiments. In the embodiment of the figures, and referring now to FIGS. 9-11, the caster wheel assembly 12 includes—as its primary components and assemblies—a base assembly 22, a caster wheel 24, and a thermal management assembly 26. Still, in other embodiments, the caster wheel assembly could have more, less, and/or different primary components and assemblies.

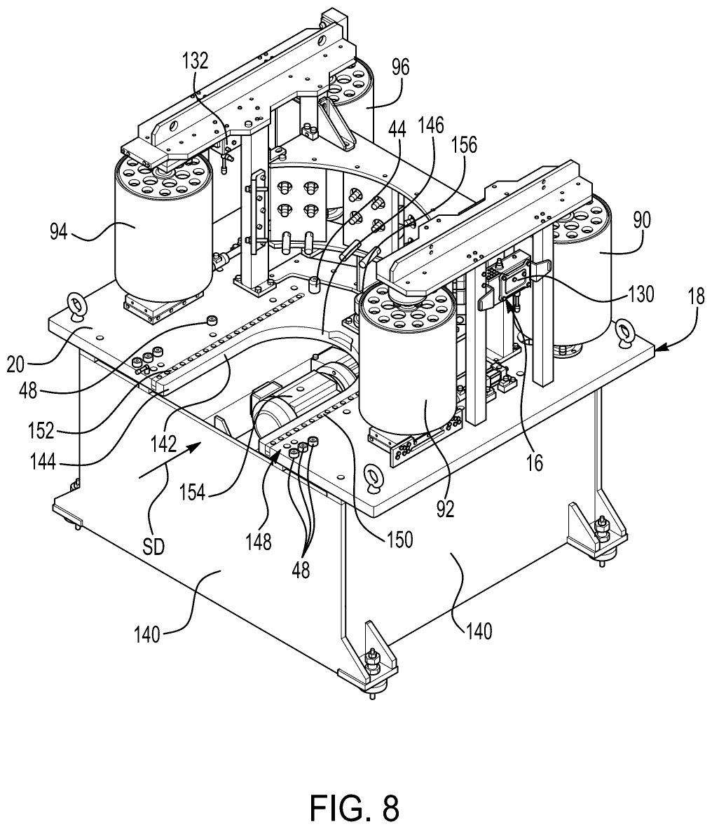

The base assembly 22 constitutes the lowermost construction of the caster wheel assembly 12 relative to the caster wheel 24 and the thermal management assembly 26. The base assembly 22 carries and supports the caster wheel 24 and the thermal management assembly 26. The base assembly 22 is situated most directly atop the continuous casting machine 10 and on the top wall 20 of the frame 18. According to this embodiment, the base assembly 22 includes a base component 28, a ring component 30, a ring gear 32, and a set of bearings 34. The base component 28 has an internal opening for accommodating parts of the thermal management assembly 26. Handles 36 mounted at a front end 38 of the base component 28 provide user handling of the caster wheel assembly 12 and a means of forward and rearward pushing and pulling of the caster wheel assembly 12 with respect to the frame 18 amid installation and uninstallation procedures. A rear end 40 of the base component 28 has a pair of notches 42 (only one depicted in FIG. 9) for engagement with corresponding guide stops 44 (FIG. 8) at the frame's top wall 20. Furthermore, sides 46 of the base component 28 engage a multitude of guides 48 amid installation and uninstallation procedures. The guides 48 pilot lateral alignment of the base assembly 22, and hence of the caster wheel assembly 12, amid installation and forward movement thereof.

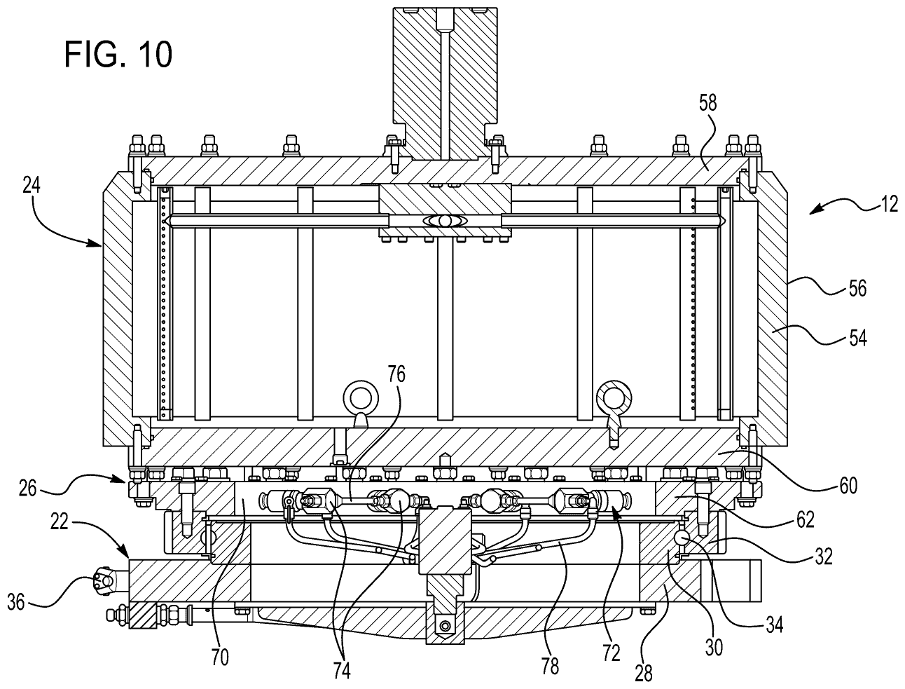

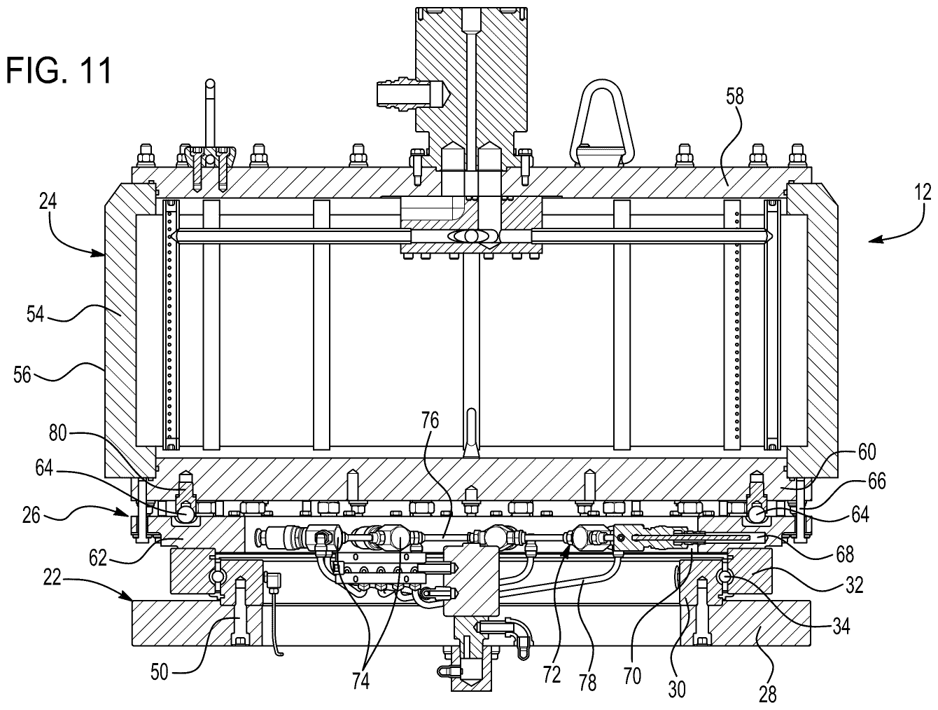

With reference now to FIGS. 10 and 11, the ring component 30 is affixed directly atop the base component 28 via bolts 50. Like the base component 28, the ring component 30 has an internal opening for accommodating parts of the thermal management assembly 26. The ring gear 32 is situated radially-outboard of the ring component 30 and axially-above the base component 28 (the terms radially and axially are used here with reference to the circular and cylindrical shape of the caster wheel 24). The ring gear 32 is affixed directly beneath a second ring component (introduced below) of the thermal management assembly 26 via bolting. External gear teeth 52 (FIG. 9) of the ring gear 32 mesh with gear teeth of a drive gear (introduced below) during operation of the continuous casting machine 10. The ring gear 32 is driven to rapidly rotate with respect to the base component 28 and with respect to the ring component 30. Rapid rotation of the ring gear 32 causes rapid rotation of the caster wheel 24. The thermal management assembly 26 can also rapidly rotate during operation of the continuous casting machine 10. The set of bearings 34 is disposed at an interfacial region between the ring component 30 and the ring gear 32, and serve to facilitate rotation of the ring gear 32 with respect to the ring component 30. In this embodiment, the set of bearings 34 are in the form of a set of ball bearings spanning wholly circumferentially around the interfacial region between the ring component 30 and the ring gear 32.

The caster wheel 24 constitutes the uppermost construction of the caster wheel assembly 12 relative to the base assembly 22 and the thermal management assembly 26. Referring to FIGS. 9-11, the caster wheel 24 is an annular ring and cylindrical structure that serves to continuously cast a strip of a multitude of serially-connected lead-acid battery metal grids or a strip of a multitude of serially-connected bipolar battery foils amid operation of the continuous casting machine 10. The caster wheel 24 has a cylindrical wall 54 with a mold cavity 56 residing therein. The mold cavity 56 constitutes a region or more of a cylindrical outer surface of the cylindrical wall 54. The mold cavity 56 accepts delivery of molten lead during use of the continuous casting machine 10, and can be made-up of multiple individual grid or foil molds spanning wholly around the circumference of the caster wheel 24. The cylindrical wall 54 is affixed to a top wall and flange assembly 58 at one end, and is affixed to a bottom wall and flange assembly 60 at its opposite end; bolting can be employed for these fixations. While unshown in the figures, a runner system located adjacent a top end of the cylindrical wall 54 can be provided. When provided, the runner system fluidly communicates with the mold cavity 56 and serves to facilitate and case the supply and delivery of molten lead to the mold cavity 56. The runner system can include a series of elongated and axially-directed ribs with channels residing between neighboring ribs. The channels can serve as flues for the flow of molten lead.

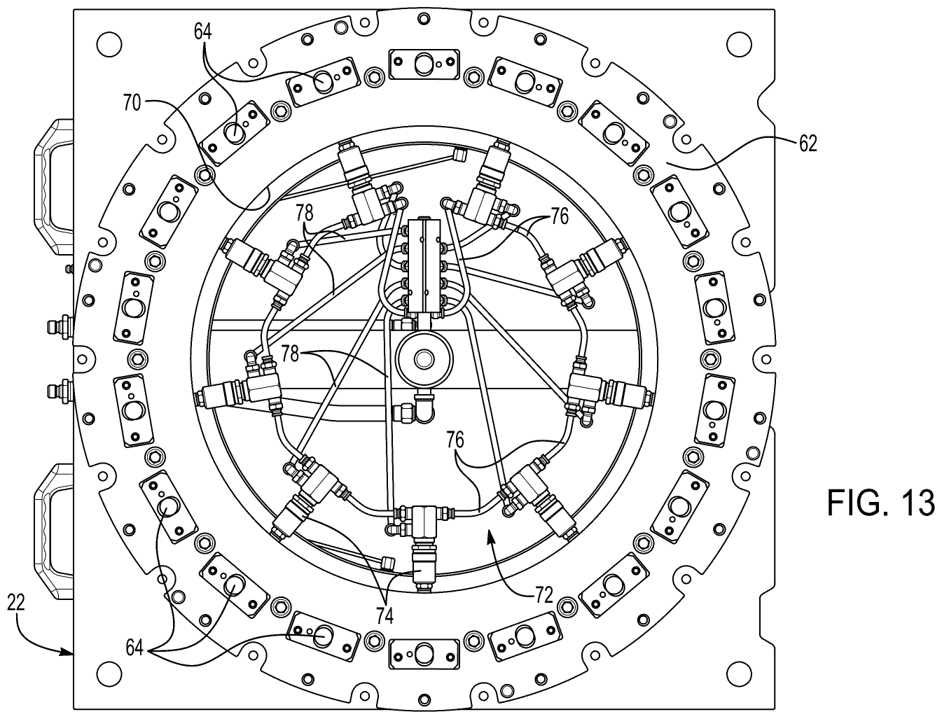

The thermal management assembly 26 constitutes the middlemost construction of the caster wheel assembly 12 relative to the base assembly 22 and the caster wheel 24, and is hence situated between the base assembly 22 and caster wheel 24. The thermal management assembly 26 provides thermal transfer management capabilities between the base assembly 22 and the caster wheel 24. It serves as a thermal barrier of sorts between the base assembly 22 and caster wheel 24, and attenuates and minimizes unwanted heat transfer and thermal conduction between the two components and assemblies. It has been observed that under certain circumstances undue heat migration to the base assembly 22 and particularly to the set of bearings 34 could thwart precision alignment and tolerances previously effected for the caster wheel assembly 12, and could inhibit proper functioning of the set of bearings 34. Moreover, undue heat removal from the caster wheel 24, it has been found, could interfere with proper casting at the caster wheel 24. The thermal management assembly 26 has been designed and constructed to resolve such risks. The thermal management assembly 26 can have varying designs, constructions, and components in varying embodiments. In the embodiment of the figures, and referring now to FIGS. 10-14, the thermal management assembly 26 includes a second ring component 62 and a multitude of load-bearing balls 64.

The second ring component 62 is affixed directly atop the ring gear 32 via bolting. During operation of the continuous casting machine 10, the second ring component 62 is driven to rapidly rotate via the ring gear 32. Opposite the ring gear 32, the second ring component 62 is affixed directly to the caster wheel 24 and particularly to the bottom wall 60 via bolts 66. For cooling purposes and in order to preclude an undue increase in temperature as a consequence of its location adjacent the caster wheel 24, one or more coolant passages 68 are defined in and reside in the second ring component 62. The coolant passage(s) 68 can span wholly around an interior of the second ring component's structure. Coolant fluid-flow, such as water fluid-flow, can be recirculated through the coolant passage(s) 68 amid operation. An internal opening 70 of the second ring component 62 accommodates a coolant injection assembly 72. The coolant injection assembly 72 supplies and injects coolant fluid-flow to the coolant passage(s) 68 for introduction of coolant into the second ring component 62, and also permits exit of heated coolant coming out of the coolant passage(s) 68. A multitude of injectors 74 are equipped in the second ring component 62 adjacent the internal opening 70 and fluidly communicate with the coolant passage(s) 68. Coolant entry piping 76 and coolant exit piping 78 furnish circulation of the coolant fluid-flow via the coolant injection assembly 72. In an example, the coolant injection assembly 72 and coolant passage(s) 68 keep the temperature of the second ring component 62 to less than approximately one-hundred degrees Fahrenheit (<100° F.); still, other examples with other cooling temperatures are indeed possible.

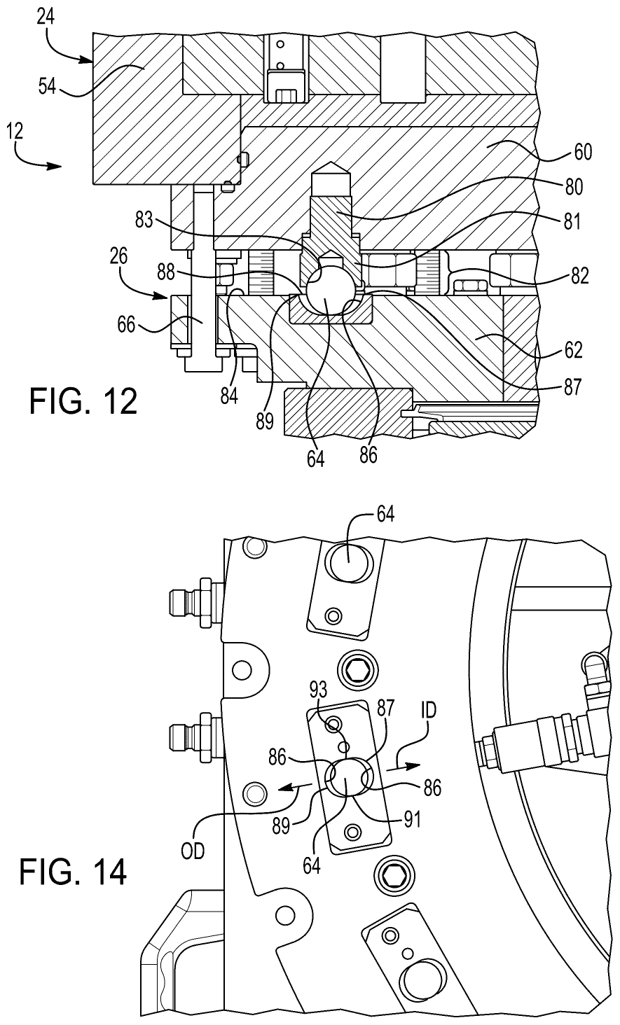

With reference to FIGS. 11-14, the load-bearing balls 64 assist in support of the caster wheel 24 at the thermal management assembly 26 and on the base assembly 22, and assist in minimizing undesired heat transfer and thermal conduction thereat. The load-bearing balls 64 are located adjacent a lower end of the caster wheel 24 and, particularly, are situated beneath the bottom wall 60 and extend therefrom. The load-bearing balls 64 are arranged circumferentially around the second ring component 62. In the embodiment here, there can be a total of eighteen load-bearing balls 64; still, in other embodiments other quantities of load-bearing balls could be provided. A multitude of stem bolts 80 are threaded directly into the bottom wall 60 and extend axially and vertically downward therefrom. The stem bolts 80 engage the load-baring balls 64, and in this embodiment sit directly on top of the load-bearing balls 64. One stem bolt 80 is provided for each load-bearing ball 64. The load-bearing balls 64 and stem bolts 80 raise the caster wheel 24 vertically and axially above the second ring component 62. A vertical gap and clearance 82 resides between the caster wheel 24 and the second ring component 62 and is defined between the confronting surfaces thereat. The vertical gap 82 is an axial gap in this embodiment (the term axial is used here with reference to the circular and cylindrical shape of the caster wheel 24). The vertical gap 82 contributes to the minimization of heat transfer and thermal conduction thereat. A head 81 of each stem bolt 80 has a recess 83 for accepting engagement and seating of the associated load-bearing ball 64, as shown best in the enlarged view of FIG. 12.

With particular reference to FIGS. 12 and 14, at an upper surface 84 of the second ring component 62, a multitude of recesses and clearances 86 can be defined and can reside thereat for accepting engagement and seating of the load-bearing balls 64. The recesses 86 can be precision-machined pockets. The load-bearing balls 64 sit directly in the recesses 86. One recess 86 is provided for each load-bearing ball 64. The recesses 86 are sized slightly larger than a diameter of the load-bearing balls 64 at a radially-inward side 87 and at a radially-outward side 89 in order to accommodate slight heat expansion of the caster wheel 24 and cylindrical wall 54, as well as that of the bottom wall 60, in an inboard and outboard direction ID, OD during operation of the continuous casting machine 10, should such heat expansion occur. The second ring component 62, on the other hand, can experience much less heat expansion or none at all as a consequence of relative stability in temperature via the thermal management assembly 26. Differentiation in temperature and expansion is thus encountered at the interfacial region between the caster wheel 24 and second ring component 62. A recess spacing 88 is provided at the radially-inward and radially-outward sides 87, 89 for accommodating the heat expansion of the caster wheel 12 and the differentiation with respect thereto of the second ring component 62. In an embodiment, the recess spacings 88 can be provided at both of the radially-inward and radially-outward sides, 87, 89, at only the radially-inward sides 87, or at only the radially-outward sides 89. At first and second circumferential sides 91, 93, on the other hand, the recesses 86 are sized to provide a precise surface-to-surface engagement and fit with the opposing load-bearing ball regions. The surface-to-surface engagement effects suitable rotational motion and movement transmission from the second ring component 62 and to the caster wheel 24 amid operation of the continuous casting machine 10. Moreover, accommodating heat expansion as described has been shown to preserve the precision alignment and tolerances put in place for the caster wheel 24 and maintain side-to-side torque transfer tolerances. The load-bearing balls 64 can be composed of a material that can bear relatively increased loads imparted from the caster wheel 24, and that possesses a low thermal conductivity property. In an embodiment, the load-bearing balls 64 are composed of a zirconium material; still, other material compositions are possible in other embodiments. Furthermore, the load-bearing balls 64 can each possess a diameter of approximately 0.75 inches, per an embodiment; still, other diameter values are possible in other embodiments.

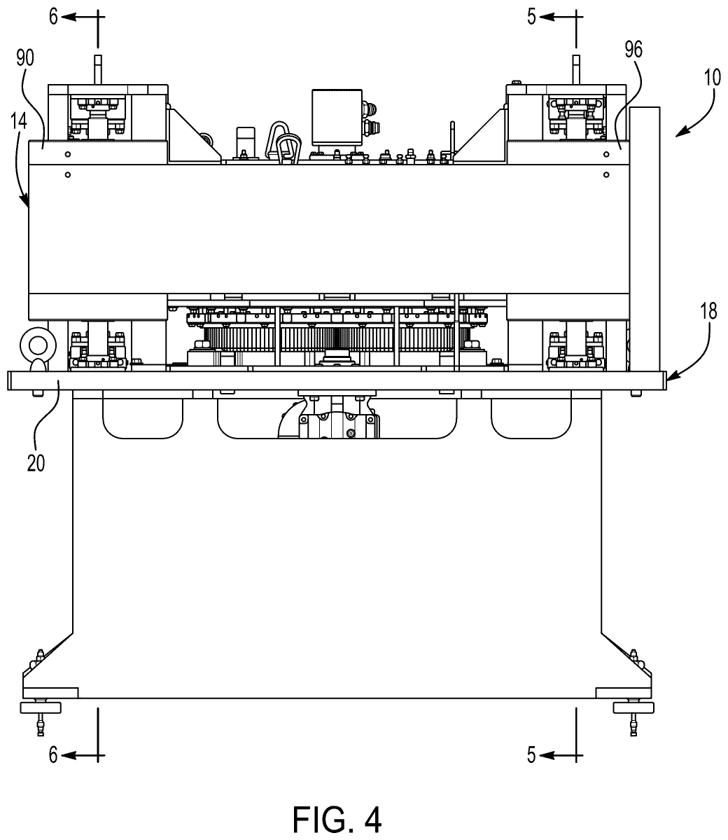

With reference now to FIGS. 1-4, the moveable belt 14 comes into direct confrontation with a moving circumferential section of the caster wheel 24 in order to continuously cast a strip of a multitude of serially-connected lead-acid battery metal grids or a strip of a multitude of serially-connected bipolar battery foils amid operation of the continuous casting machine 10. The moveable belt 14 overlies the mold cavity 56 and can overlie the runner system, and is urged against the caster wheel 24 in sealing engagement at the section in which molten lead is delivered into the mold cavity 56 and sufficiently downstream thereof for the molten lead to substantially solidify before the subject battery component strip exits the mold cavity 56. Movement of the caster wheel 24 drives movement of the moveable belt 14. In construction, the moveable belt 14 can possess a vertical and transverse width that is greater than the vertical and axial extent of the mold cavity 56 and the runner system. Further, the moveable belt 14 can be composed of a stainless steel material, can be endless, and can be relatively thin and flexible in nature. In embodiments in which the moveable belt 14 moves at the same tangential speed as the caster wheel 24, there may be no relative movement between the moveable belt 14 and caster wheel 24; here, it has been found that friction is minimized or substantially lacking therebetween, and hence a lead antimony alloy with an antimony content of approximately three percent (3%) by weight, for example—previously unavailable—can be utilized as the material of the subject battery component. Still, in other embodiments, relative movement may exist between the moveable belt 14 and caster wheel 24 amid operation of the continuous casting machine 10.

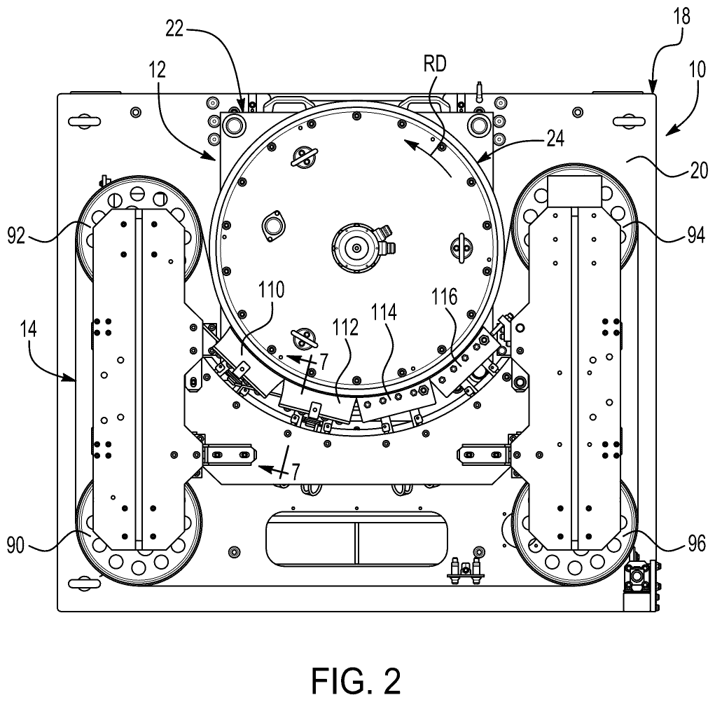

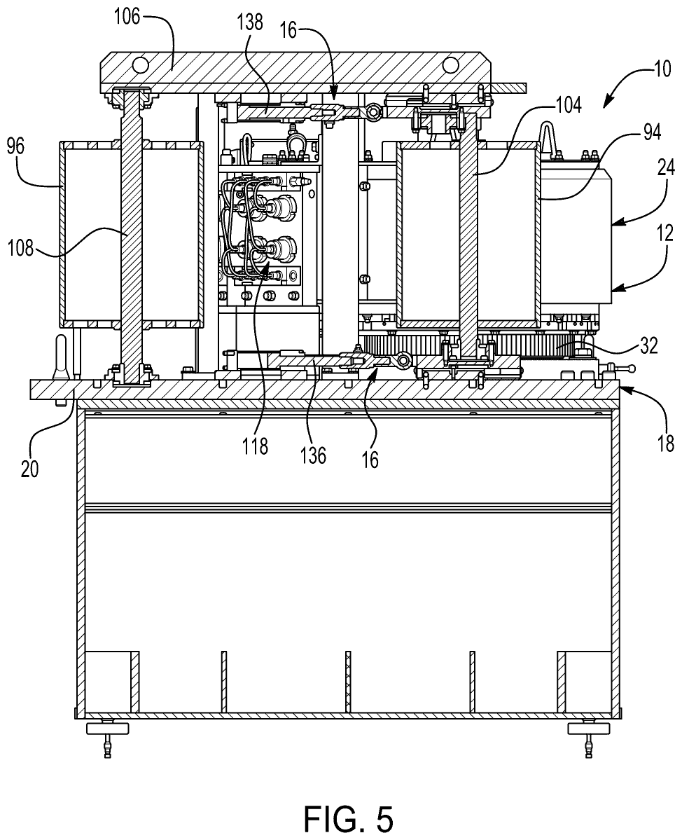

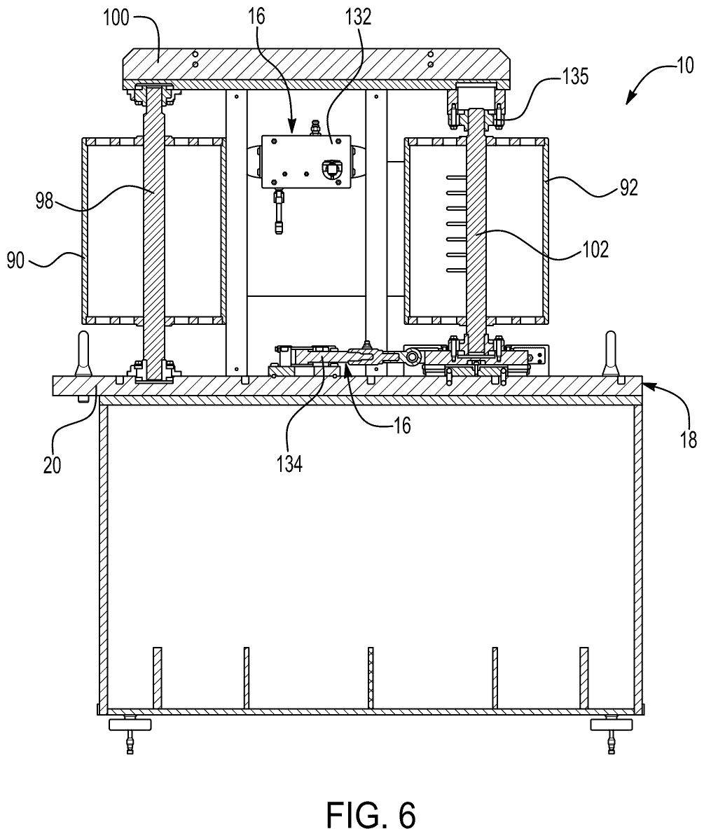

The rollers support continuous movement of the moveable belt 14 amid operation of the continuous casting machine 10, and are mounted on the top wall 20 of the frame 18. In this embodiment there are a total of four rollers—a first roller 90, a second roller 92, a third roller 94, and a fourth roller 96; still, in other embodiments there could be other quantities of rollers. The first and second rollers 90, 92 are situated at an upstream side of the shoes with respect to a rotational direction RD (FIG. 2) of the caster wheel 24 during use of the continuous casting machine 10. The third and fourth rollers 94, 96, on the other hand, are situated at a downstream side of the shoes relative to the rotational direction RD. The first, second, third, and fourth rollers 90, 92, 94, 96 are journaled for rotation at their respective locations via associated shafts. With reference now to FIGS. 5 and 6, a first shaft 98 of the first roller 90 extends vertically from the top wall 20 and to a first support bar 100. A second shaft 102 of the second roller 92 similarly extends vertically from the top wall 20 and to the first support bar 100. Further, a third shaft 104 of the third roller 94 extends vertically from the top wall 20 and to a second support bar 106, and likewise a fourth shaft 108 of the fourth roller 96 extends vertically from the top wall 20 and to the second support bar 106.

The shoes can serve to urge the moveable belt 14 into firm sealing engagement with the caster wheel 24 and, depending on their arrangement and type, can serve to promote full filling with molten lead of the complete vertical extent of the associated section of the mold cavity 56 and/or can serve to promote rapid solidification of the molten lead in the mold cavity 56. There can be varying quantities and arrangements of the shoes in varying embodiments, and the shoes themselves can have varying designs, constructions, and components in varying embodiments. In the embodiment of the figures, and with particular reference to FIGS. 1 and 2, a total of four shoes are provided—a first heating shoe 110, a second heating shoe 112, a first cooling shoe 114, and a second cooling shoe 116; still, in an alternative embodiment, a pair of shoes could be provided (e.g., a heating shoe and a cooling shoe). Having a pair of heating shoes and a pair of cooling shoes has been found to facilitate a faster run-rate of battery component manufacture during operation of the continuous casting machine 10. The first and second heating shoes 110, 112 can exhibit an arcuate front face for complementary confrontation with the caster wheel 24, and the first and second cooling shoes 114, 116 can likewise exhibit an arcuate front face for the same purpose.

The first and second heating shoes 110, 112 and the first and second cooling shoes 114, 116 are situated immediately next to one another, with the first and second heating shoes 110, 112 positioned upstream relative to the first and second cooling shoes 114, 116, and hence the first and second cooling shoes 114, 116 being downstream of the first and second heating shoes 110, 112 (the terms upstream and downstream are used here with reference to the rotational direction RD of the caster wheel 24). The first and second heating shoes 110, 112 are situated at the site of molten lead supply and delivery between the caster wheel 24 and moveable belt 14 in order to aid complete filling with molten lead of the associated section of the mold cavity 56 prior to solidification occurring. Molten lead can more readily make its way to a lower and bottom region of the mold cavity 56 with use of the first and second heating shoes 110, 112. The first and second heating shoes 110, 112 can be equipped with internal electric heating elements to generate increased heat within the heating shoes 110, 112 themselves. The generated heat is, in turn, furnished from the first and second heating shoes 110, 112 and to the moveable belt 14 and to the associated section of the mold cavity 56 via the engagements thereamong. Conversely, to actively decrease the temperature of, and hence cool, the first and second cooling shoes 114, 116, liquid coolant supply and return lines can communicate with interior passages of the first and second cooling shoes 114, 116 for circulation therethrough.

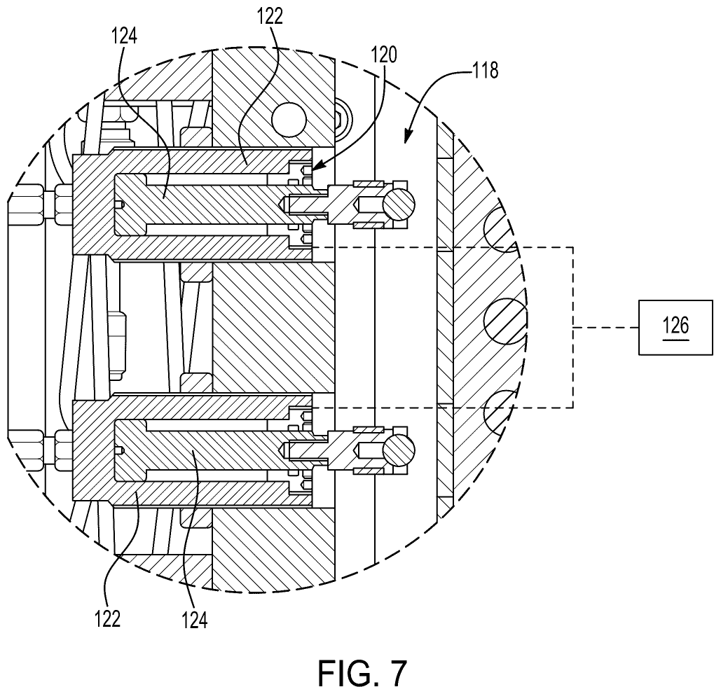

To exert greater urging forces with greater command and control—as well as to provide enhanced engagement among the shoes and moveable belt 14 and caster wheel 24—one or more or all of the heating and cooling shoes 110, 112, 114, 116 can be equipped with a controllable force application assembly 118. The controllable force application assembly 118 provides regulable and independent urging force exertions via the associated heating and/or cooling shoes 110, 112, 114, 116. The controllable force application assembly 118 can have varying designs, constructions, and components in varying embodiments. In the embodiment of the figures, and with reference to FIG. 7, the controllable force application assembly 118 is of the hydraulic type. Hydraulic arrangements and assemblies 120 are equipped at each of the first and second heating shoes 110, 112 and first and second cooling shoes 114, 116. The hydraulic arrangements 120 provides urging forces from the shoes and resulting pressure applications to the moveable belt 14. Cylinders 122 and pistons 124 are disposed at upper and lower regions of the shoes 110, 112, 114, 116. There can be a total of four cylinders 122 and four pistons 124 at each of the shoes 110, 112, 114, 116, according to this embodiment; still, in other embodiments other quantities could be provided. Hydraulic fluid and pressure is fluidly communicated to the hydraulic arrangements 120 and to and from interior bores of the cylinders 122 and pistons 124 amid urging force application. One or more pressure regulator valves can be installed adjacent and/or within accompanying hydraulic lines in order to regulate hydraulic pressure thereat. A controller 126, such as a programmable logic controller (PLC), can electrically communicate with the hydraulic arrangements 120 and can command and control activations and deactivations thereof. The controller 126 can receive inputs from the hydraulic arrangements 120 such as hydraulic pressure readings at the cylinders 122 and pistons 124. Independent and active control and adjustment of urging force exertions is effected via the hydraulic arrangements 120 and controller 126. In an example, a first urging force is exerted from one or both of the first and second heating shoes 110, 112 and to the moveable belt 14, and a second urging force is exerted from one or both of the first and second cooling shoes 114, 116 and to the moveable belt 14. The first and second urging forces can exhibit different magnitudes with respect to each other. Moreover, the first and second urging forces can be adjustable—i.e., increased or decreased magnitudes—during operation of the continuous casting machine 10.

The belt tensioning assembly 16 serves to adjust and maintain the desired tension of the moveable belt 14 on the first, second, third, and fourth rollers 90, 92, 94, 96 during operation of the continuous casting machine 10. It has been found that, in certain circumstances, the moveable belt 14 can have a tendency to migrate vertically up and down on the rollers 90, 92, 94, 96 during use, as a consequence of heat expansion and contraction and as a consequence of the exerted urging forces of the heating and cooling shoes 110, 112, 114, 116. Such migration and movement is unwanted, as it could negatively impact the efficiency and effectiveness of the machine's operation. It has been shown that maintaining proper tensioning on the moveable belt 14 can minimize or altogether preclude this unwanted occurrence. The belt tensioning assembly 16 can have varying designs, constructions, and components in varying embodiments. In the embodiment of the figures, and referring to FIGS. 1, 3, 5, 6, 8, includes a sensing system 128 and multiple actuators. The sensing system 128 has a first laser sensor 130 and a second laser sensor 132. The first and second laser sensors 130, 132 can be image-based laser sensors. The first laser sensor 130 is mounted laterally between the first and second rollers 90, 92 and monitors and tracks the position of the moveable belt 14 as it rapidly advances thereby. In a similar manner, the second laser sensor 132 is mounted laterally between the third and fourth rollers 94, 96 and monitors and tracks the position of the moveable belt 14 as it rapidly advances thereby. The first and second laser sensors 130, 132 can be set-up to track the vertical up-and-down position of an upper edge of the moveable belt 14 relative to an intended position, or can be a lower edge of the moveable belt 14, depending on the embodiment.

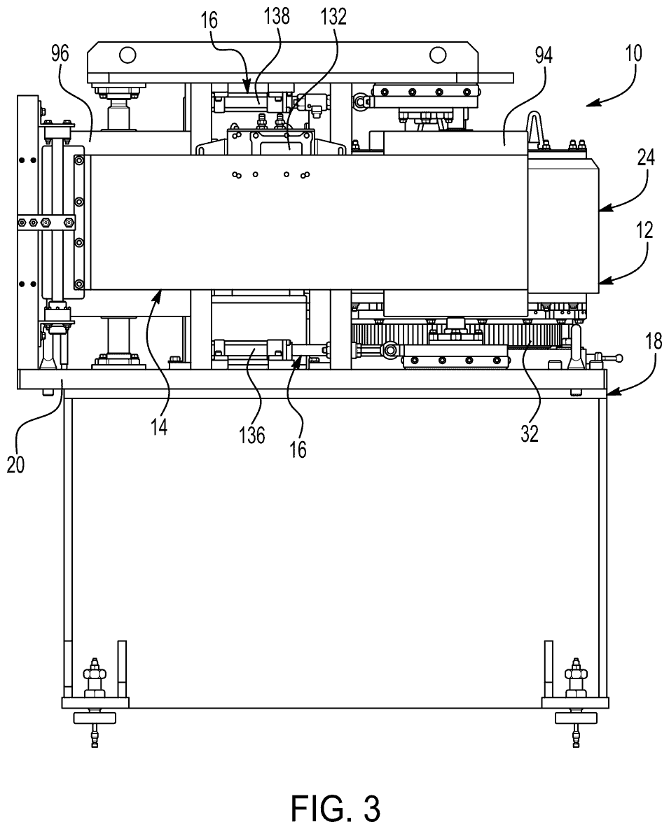

Referring to FIG. 6, a first actuator 134 can be actuated and deactuated for engagement with the second shaft 102 and for imparting back-and-forth horizontal and radial movements of the second roller 92 relative to the top wall 20 for tension modification and adjustment. An interconnection construction can be established between the first actuator 134 and the second shaft 102 for the transfer of urging force from the first actuator 134 and to the second shaft 102. The first actuator 134 engages the second roller 92 and second shaft 102 at a lower end thereof. Opposite this engagement, and at an upper end of the second roller 92 and second shaft 102, a self-aligning bearing 135 allows the second shaft 102 to pivot thereabout amid tension adjustment movements. The second roller 92 and second shaft 102 can be carried by a translatable carriage assembly for permitting such back-and-forth translational movements. Referring now to FIGS. 3 and 5, a second and third actuator 136, 138 can be actuated and deactuated for engagement with the third shaft 104 and for imparting back-and-forth horizontal and radial movements of the third roller 94 relative to the top wall 20 for tension modification and adjustment. An interconnection construction can be established between the second actuator 136 and the third shaft 104, and another interconnection construction can be established between the third actuator 138 and the third shaft 104. The interconnections provide the transfer of urging forces from the second and third actuators 136, 138 and to the third shaft 104. The second actuator 136 engages the third roller 94 and third shaft 104 at a lower end thereof, and the third actuator 138 engages the third roller 94 and third shaft 104 at an upper end thereof. The third roller 94 and third shaft 104 can be carried by translatable carriage assemblies at the lower and upper ends for permitting such back-and-forth translational movements. In the embodiment here, the first, second, and third actuators 134, 136, 138 are in the form of hydraulic cylinder actuators, but could take other forms in other embodiments. The first, second, and third actuators 134, 136, 138 automate control of the tension of the moveable belt. Activation and deactivation of the actuators 134, 136, 138 can be carried out via the controller 126, per an example.

The frame 18 carries and supports other primary components and assemblies of the continuous casting machine 10, and facilitates installation and uninstallation of the caster wheel assembly 12. The frame 18 can have varying designs, constructions, and components in varying embodiments, some of which may be dictated in part or more by the design and construction and components of the caster wheel assembly 12. In the embodiment of the figures, and with reference to FIG. 8, the frame 18 includes the previously-introduced top wall 20 and four side walls 140. The moveable belt 14, rollers 90, 92, 94, 96, shoes 110, 112, 114, 116, and belt tensioning assembly 16 are all supported and carried at the top wall 20, among other components and assemblies possibly situated thereon. The top wall 20 has an opening 142 defined and residing therein for accepting insertion and receipt of the caster wheel assembly 12. The opening 142 has a general U-shape with an open end 144 located at a front edge of the top wall 20, and has a closed end 146 located somewhat centrally at the top wall 20 and opposite of the open end 144. The open end 144 initially accepts insertion of the base assembly 22 and caster wheel assembly 12 upon installation thereof. Side edges of the opening 142 extending between the open and closed ends 144, 146 are linear in extent. Part of the caster wheel assembly 12 can be received laterally within the opening 142 upon installation, per this embodiment. Components of the coolant injection assembly 72, for example, can span at least partially downward and through the opening 142. Overhanging side portions of the base component 28 rest on and are supported atop the top wall 20, as perhaps depicted best in FIG. 1. Placement and insertion of the caster wheel assembly 12 amid installation can occur primarily by way of a side direction SD, as represented by the arrowed line in FIG. 8. The side direction SD is also a lateral direction. The base assembly 22 can be slid into place at the top wall 20 via the side direction SD. Placement by way of the side direction SD has been shown to provide ready handling and serviceability of the caster wheel assembly 12 for installation and uninstallation purposes.

Furthermore, for facilitating placement and sliding of the caster wheel assembly 12 and of the base assembly 22, a guidance assembly 148 is equipped and located at the frame's top wall 20. In this embodiment, and with continued reference to FIG. 8, the guidance assembly 148 includes several guide structures and a pair of bearing sets. The guide structures include the previously-introduced guide stops 44 and guides 48. In cooperation with the base assembly 22, the guide stops 44 index longitudinal installation depth of the caster wheel assembly 12, while the guides 48 pilot lateral alignment of the caster wheel assembly 12 with respect to the top wall 20 of the frame 18. The bearing sets are in the form of a first ball bearing rail 150 and a second ball bearing rail 152. Furthermore, the first and second ball bearing rails 150, 152 can be in the form of hydraulically-operated ball die lifters that are actuatable to come into engagement with the caster wheel assembly 12 and its base assembly 22 amid installation and uninstallation actions. The first and second ball bearing rails 150, 152 are disposed in slots in the top wall 20 on opposing sides of the opening 142 relative to each other, and are directed generally in-line with the insertion side direction SD. An underside surface of the base component 28 rides on the first and second ball bearing rails 150, 152. Still, in other embodiments the guidance assembly 148 could have other designs, constructions, and components.

Yet further, in order to drive rapid rotation of the caster wheel assembly 12 during operation of the continuous casting machine 10, a drive motor 154 is supported at the frame 18. The drive motor 154 can be of the variable speed electric motor type, per this embodiment. As illustrated partially in FIG. 8, the drive motor 154 can be positioned beneath the top wall 20 and within an interior of the frame 18. A drive gear 156 of the drive motor 154 comes into direct gear-teeth-to-gear teeth engagement with the ring gear 32. A gearbox can be interconnected between the drive motor 154 and the drive gear 156. The drive gear 156 protrudes from the frame's interior and above the top wall 20 via a throughway opening residing in the top wall 20. At its protruded location, the drive gear 156 is positioned for engagement with the ring gear 32 when the caster wheel assembly 12 is installed. Activation and deactivation of the drive motor 154 can be controlled via the controller 126.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not strictly possible. In other instances, the terms “general,” “generally,” “approximately,” and “substantially” are intended to represent the inherent degree of uncertainty that is often attributed to any quantitative comparison, value, and measurement calculation, or other representation, such that mathematical precision and exactitude is not implied and, in some instances, is not strictly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A quick-change belt caster wheel assembly for a battery component continuous casting machine, the quick-change belt caster wheel assembly comprising:
a base assembly situatable atop the battery component continuous casting machine, said base assembly comprising a ring gear and a set of bearings facilitating rotation of said ring gear;
a caster wheel carried by said base assembly and rotatable with respect to said base assembly, said caster wheel driven to rotate via said ring gear, said caster wheel having a cylindrical wall with a mold cavity residing therein; and
a thermal management assembly located between said base assembly and said caster wheel, said thermal management assembly attenuating heat transfer between said caster wheel and said base assembly.

2. The quick-change belt caster wheel assembly as set forth in claim 1, wherein said thermal management assembly comprises a ring component, said ring component having at least one coolant passage residing therein for circulation of coolant fluid-flow.

3. The quick-change belt caster wheel assembly as set forth in claim 2, wherein said ring component is affixed with said ring gear of said base assembly.

4. The quick-change belt caster wheel assembly as set forth in claim 1, wherein said thermal management assembly comprises a plurality of load-bearing balls located adjacent a lower end of said caster wheel, said plurality of load-bearing balls composed of a low thermal conductivity material.

5. The quick-change belt caster wheel assembly as set forth in claim 4, wherein said plurality of load-bearing balls are composed of a zirconium material.

6. The quick-change belt caster wheel assembly as set forth in claim 4, wherein said thermal management assembly comprises a ring component, and wherein said plurality of load-bearing balls are seated in a plurality of recesses residing at said ring component.

7. The quick-change belt caster wheel assembly as set forth in claim 1, wherein said base assembly comprises a ring component affixed with a base component, wherein said set of bearings is situated between said ring component and said ring gear, and said ring gear rotates with respect to said ring component.

8. The quick-change belt caster wheel assembly as set forth in claim 1, wherein said base assembly comprises a first ring component and a base component, said first ring component affixed with said base component, wherein said set of bearings is situated between said first ring component and said ring gear, and said ring gear rotates with respect to said first ring component, wherein said thermal management assembly comprises a second ring component having at least one coolant passage residing therein, said second ring component affixed with said ring gear of said base assembly, and wherein said thermal management assembly comprises a plurality of load-bearing balls composed of a low thermal conductivity material, said plurality of load-bearing balls situated between said caster wheel and said second ring component.

9. The quick-change belt caster wheel assembly as set forth in claim 1, wherein said thermal management assembly comprises a ring component having at least one coolant passage residing therein and comprises a plurality of load-bearing balls situated between said caster wheel and said ring component.

10. A battery component continuous casting machine comprising said quick-change belt caster wheel assembly as set forth in claim 1, the battery component continuous casting machine further comprising:
a frame having a top wall, wherein said quick-change belt caster wheel assembly is set in place at said top wall of said frame; and
a drive motor having a drive gear engaging said ring gear of said base assembly to drive rotation of said caster wheel.

11. The battery component continuous casting machine as set forth in claim 10, wherein an opening resides in said top wall of said frame, said opening accepts insertion of said quick-change belt caster wheel assembly when said quick-change belt caster wheel assembly is set in place at said top wall.

12. The battery component continuous casting machine as set forth in claim 10, further comprising at least one heating shoe and at least one cooling shoe, said at least one heating and cooling shoes engaging a moveable belt of the battery component continuous casting machine, said at least one heating shoe exerting a first urging force against the moveable belt, said at least one cooling shoe exerting a second urging force against the moveable belt, said first urging force and said second urging force independently and actively adjustable with respect to each other amid use of the battery component continuous casting machine.

13. The battery component continuous casting machine as set forth in claim 12, wherein said first and second urging forces are provided via hydraulic arrangements at said at least one heating and cooling shoes and via a controller regulating application of said first and second urging forces.

14. The battery component continuous casting machine as set forth in claim 10, further comprising a guidance assembly located at said top wall of said frame, said guidance assembly facilitating placement of said quick-change belt caster wheel assembly at said top wall, said guidance assembly comprising at least a second set of bearings and at least one guide structure.

15. The battery component continuous casting machine as set forth in claim 10, further comprising a moveable belt and a plurality of rollers supporting movement of said moveable belt, and further comprising a belt tensioning assembly, wherein tension of said moveable belt on said plurality of rollers is adjustable via said belt tensioning assembly, said belt tensioning assembly including at least one sensor and at least one actuator, said at least one sensor tracking a position of said moveable belt with respect to one of said plurality of rollers, and said at least one actuator engaging one of said plurality of rollers for imparting movements thereto.

16. A method of changing a belt caster wheel assembly in a battery component continuous casting machine, the method comprising:
placing a base assembly of the belt caster wheel assembly at a frame wall of the battery component continuous casting machine, the placement occurring primarily via a side direction and movement of said base assembly with respect to said frame wall.

17. The method of changing a belt caster wheel assembly in a battery component continuous casting machine as set forth in claim 16, further comprising sliding a base component of said base assembly at said frame wall and wherein an opening in frame wall accepts at least partial insertion of said base assembly therein.

18. The method of changing a belt caster wheel assembly in a battery component continuous casting machine as set forth in claim 17, wherein said opening has an open end that initially accepts the at least partial insertion of said base assembly thereat, and said opening has a closed end located opposite said open end.

19. The method of changing a belt caster wheel assembly in a battery component continuous casting machine as set forth in claim 16, further comprising providing at least one guide and at least one set of bearings at said frame wall adjacent placement of said base assembly, and engaging said at least one guide and said at least one set of bearings during the placement of said base assembly at said frame wall.

20. A belt caster wheel assembly for a battery component continuous casting machine, the belt caster wheel assembly comprising:
a caster wheel having a mold cavity;
a ring gear driving rotation of said caster wheel;
a ring component situated between said ring gear and said caster wheel, said ring component having at least one coolant passage residing therein; and
a plurality of load-bearing balls situated between said ring component and said caster wheel, wherein an axial gap resides between said ring component and said caster wheel adjacent said plurality of load-bearing balls.

21. The belt caster wheel assembly as set forth in claim 20, wherein said ring component has at least one coolant passage residing therein.

22. The belt caster wheel assembly as set forth in claim 20, wherein said plurality of load-bearing balls are composed of a low thermal conductivity material.

23. The belt caster wheel assembly as set forth in claim 20, further comprising a plurality of stem bolts extending from said caster wheel and engaging said plurality of load-bearing balls, and wherein said axial gap is established via said plurality of stem bolts and via said plurality of load-bearing balls.

24. The belt caster wheel assembly as set forth in claim 20, wherein said ring component has a plurality of recesses residing at least adjacent an upper surface of said ring component, said plurality of load-bearing balls seated in said plurality of recesses.

25. The belt caster wheel assembly as set forth in claim 24, wherein a plurality of recess spacings is provided at radially-inward sides of said plurality of recesses, is provided at radially-outward sides of said plurality of recesses, or is provided at both radially-inward sides and radially-outward sides of said plurality of recesses, said plurality of recess spacings accommodating heat expansion of said caster wheel during use of the battery component continuous casting machine.

26. The belt caster wheel assembly as set forth in claim 24, wherein a surface-to-surface engagement is established between said plurality of recesses and said plurality of load-bearing balls at circumferential sides of said plurality of recesses, said surface-to-surface engagements effecting rotational motion transmission from said ring component to said caster wheel.

27. A battery component continuous casting machine comprising said belt caster wheel assembly as set forth in claim 20.
